(19) United States
(12) Patent Application Publication
(10) Pub. No.: US 2006/0218404 A1
(43) Pub. Date: Sep. 28, 2006

(54) Scanning device and document management system including the same

(75) Inventor: Kazuhiro Ogura, Kanagawa-ken (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/264,470

(22) Filed: Oct. 31, 2005

(30) Foreign Application Priority Data
Mar. 22, 2005 (JP) 2005-082039

(51) Int. Cl. H04L 9/00

(52) U.S. Cl. 713/178

(57) ABSTRACT

A document management system includes a scanning device for reading necessary documents, such as contract documents and approval documents, that are required to be maintained, and generating scanned document data; a plurality of primary time-stamping servers for issuing time stamps with varying degrees of reliability, each server adding a time stamp to the scanned document data generated; a server selector for selecting a specific primary time-stamping server from the plurality of primary time-stamping servers according to the degree of importance of the scanned document data; and a document management server for receiving and storing the scanned document data with a time stamp given by the selected primary time-stamping server. The scanning device is configured to use one of the plurality of primary time-stamping servers to add a time stamp to scanned document data.

### BACKGROUND OF THE INVENTION

1. Field of the Invention

The present invention relates to anti-tampering techniques in which a time stamp is added to scanned document data, and particularly to a scanning device with anti-tampering functions, and to a document management system that includes the scanning device.

2. Description of the Related Art

Image reading techniques for reading graphics and text in a document are applied, for example, to electrophotographic digital copiers, multi-function printers (MFPs), and scanning apparatuses, such as image scanners. There are document management systems that allow, for the prevention of tampering, a time stamp to be added to scanned document data obtained by a scanning device, and then allow the time-stamped data to be stored in and managed by a document management server.

In a known document management system disclosed in JP-A 2004-265090, a client terminal is connected to and has access to a time-stamping server via a LAN. Scanned document data of a certificate or the like processed by the client terminal is given a time stamp by the time-stamping server. The time-stamped and authenticated scanned document data is returned to the client terminal and stored on a hard disk of the client terminal.

Known document management systems cause a client terminal to send scanned document data via a LAN to a time-stamping server, which is a given time-stamping authority, where a time stamp is added to the scanned document data, while allowing the time-stamped scanned document data to be returned to the client terminal. However, if the time-stamping server is busy or down and unavailable, and thus is not accessible, the scanned document data cannot receive time authentication therefrom.

The client terminal generates various types of scanned document data according to the types of jobs. The levels of importance of these various types of scanned document data are not necessarily the same.

Time-stamping servers, that is, time-stamping authorities include both public and private time-stamping authorities. The private time-stamping authorities include time-stamping authorities (time-stamping servers) with varying degrees of reliability associated with their brands. Their server fees vary depending on the reliability of the time stamps and brand reliability.

Known document management systems allow a client terminal to connect to and use a given time-stamping authority only. Therefore, if the given time-stamping authority is currently connected to another client terminal or is down, the client terminal needs to wait until the time-stamping authority becomes accessible. It is not possible for the client terminal to select an appropriate time-stamping authority according to the degree of importance of the job.

### SUMMARY OF THE INVENTION

The present invention has been achieved in view of the circumstances described above. An object of the present invention is to provide a scanning device that provides anti-tampering functions, can select an appropriate time-stamping authority according to the degree of importance of the scanned document data, and has increased accessibility to time-stamping authorities; and to provide a document management system including the scanning device.

Another object of the present invention is to provide a scanning device that selects a time-stamping authority with higher reliability according to the job type or the degree of importance of the job, performs the time authentication of scanned document data in a timely manner without a time lag, and thus provides improved anti-tampering functions; and to provide a document management system including the scanning device.

To solve the problems described above, in an aspect of the present invention, a document management system includes a scanning device for reading necessary documents, such as contract documents and approval documents, that are required to be maintained, and generating scanned document data; a plurality of primary time-stamping servers for issuing time stamps with varying degrees of reliability, each server adding a time stamp to the scanned document data generated; a server selector for selecting a specific primary time-stamping server from the plurality of primary time-stamping servers according to the degree of importance of the scanned document data; and a document management server for receiving and storing the scanned document data with a time stamp given by the selected primary time-stamping server, wherein the scanning device is configured to use one of the plurality of primary time-stamping servers to add a time stamp to scanned document data.

To solve the problems described above, in another aspect of the present invention, a scanning device for adding a time stamp to scanned document data by using one of a plurality of primary time-stamping servers includes a central control unit such as a CPU; a control panel for controlling the central control unit; a data reader for reading necessary documents, such as contract documents and approval documents, that are required to be maintained, and generating scanned document data under the control of the central control unit; a server selector for selecting a specific primary time-stamping server from the plurality of primary time-stamping servers according to the degree of importance of the scanned document data; a data transmitter for sending generated scanned document data to a specific primary time-stamping server; and a data receiver for receiving scanned document data with a time stamp given by a specific primary time-stamping server, wherein the data transmitter is configured such that scanned document data with a time stamp is sent to and stored on a document management server.

In the scanning device of the present invention and the document management system including the scanning device, a specific primary time-stamping server can be selected from a plurality of primary time-stamping servers according to the degree of importance of the scanned document data. This allows easy access to a primary time-stamping server that issues time stamps with reliability best suited for the degree of importance of the scanned document data, and increases accessibility to a primary time-stamping server functioning as a time-stamping authority.

In the scanning device of the present invention and the document management system including the scanning device, time-stamping authorities (time-stamping servers) with higher reliability can be selected according to the job type or the degree of importance of the job, and a backup time-stamping server corresponding to each primary time-stamping server can be used under given conditions. This allows the time authentication of scanned document data to be performed in a timely manner without a time lag, and thus improves anti-tampering functions.

### BRIEF DESCRIPTION OF THE DRAWINGS

FIG. 1 shows the system structure of an embodiment of the document management system of the present invention.

FIG. 2 shows the basic structure of the scanning device included in the document management system of the present invention.

FIG. 3 is a flowchart showing an example of a series of document management operations in the document management system of the present invention.

FIG. 4 is a flowchart showing another example of a series of document management operations in the document management system of the present invention.

### DESCRIPTION OF THE PREFERRED EMBODIMENTS

Embodiments of the scanning device and document management system including the scanning device, according to the present invention, will now be described with reference to the attached drawings.

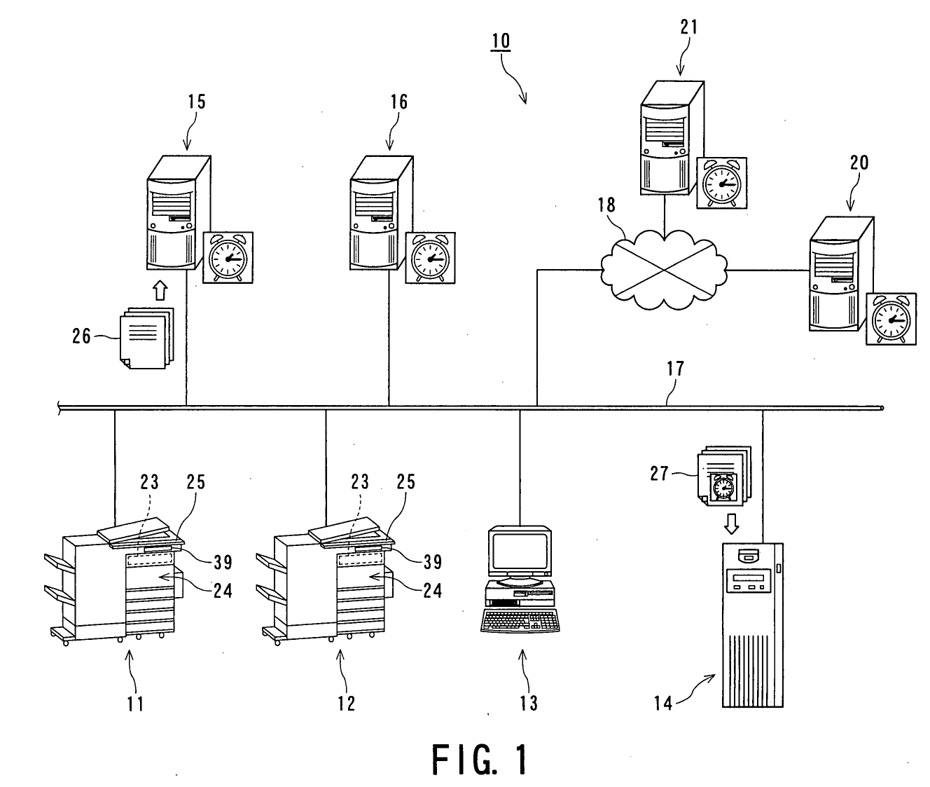

FIG. 1 shows the system structure of an embodiment of the document management system of the present invention. A document management system 10 includes a plurality of MFPs 11 and 12, a client PC 13, a document management server 14, a private (in-house) primary time-stamping server 15, and a private (in-house) backup time-stamping server 16 that are connected via a system bus 17 through a LAN. The private primary and backup time-stamping servers 15 and 16 serve as private (in-house) time-stamping authorities. The MFPs 11 and 12, the client PC 13, and the like are connected via a communication line 18, such as the Internet, to a public primary time-stamping server 20 and to a public backup time-stamping server 21 that serve as public time-stamping authorities.

Each of the MFPs 11 and 12 includes a scanning device 23 for reading document data including graphics data, and a printing device 24 for printing the read document data. Each scanning device 23 is controlled, via a central control unit (not shown) such as a CPU, with the operation of a control panel 25 on top of the main casing of each of the MFPs 11 and 12. Document data including graphics data is thus read and converted into electronic form. The MFPs 11 and 12 may be replaced with digital copiers or scanning apparatuses, such as image scanners.

Scanned document data 26 including graphics data read by the scanning device 23 of each of the MFPs 11 and 12 is given a time stamp for preventing tampering.

Companies (clients) deal with various types of scanned document data 26 to accommodate various job types and the various degrees of importance of jobs. The scanned document data 26 is based on documents, such as contract documents, technical documents including design drawings, approval documents (requests for managerial decisions), minutes, and receipts that are required to be maintained. Such documents are categorized into documents that are necessary to be maintained based on the company's specific needs, and documents that are mandated to be maintained by law. The documents to be maintained are ranked according to the degree of importance of the job. The way of ranking is described in advance in a manual in a systematic manner, according to the job type or the degree of importance of the job, and with respect to each type of document.

The control panel 25 for each scanning device 23 is provided with template buttons. Pressing the template buttons, at the time of scanning a document, allows the selection of one of the time-stamping servers 15, 16, 20, and 21 according to the job type or the degree of importance of the job.

It is specified in contracts in advance such that each of the MFPs 11 and 12 and the client PC 13 is connected to the private time-stamping servers 15 and 16 via the LAN, and to the public time-stamping servers 20 and 21 via the communication line 18, and is accessible to the time-stamping servers 15, 16, 20, and 21.

One of the private time-stamping servers 15 and 16 is provided as a primary access server for the MFPs 11 and 12 and the client PC 13, while the other (private backup time-stamping server 16) is provided as a backup access server. Similar to the private time-stamping servers 15 and 16, one of the public time-stamping servers 20 and 21 is provided as a primary access server, while the other is provided as a backup access server. Three or more private time-stamping servers, which are ranked, and three or more public time-stamping servers, which are also ranked, may be provided unlike those illustrated in FIG. 1. The reliability of time stamps from the backup time-stamping servers 16 and 21 is at least equal to that of time stamps from the primary time-stamping servers 15 and 20.

In general, the reliability of time stamps and the server fees of the public time-stamping servers 20 and 21 are higher than those of the private time-stamping servers 15 and 16. Moreover, the server fees of the two private time-stamping servers 15 and 16 are different because of a difference in reliability associated with corporate brands.

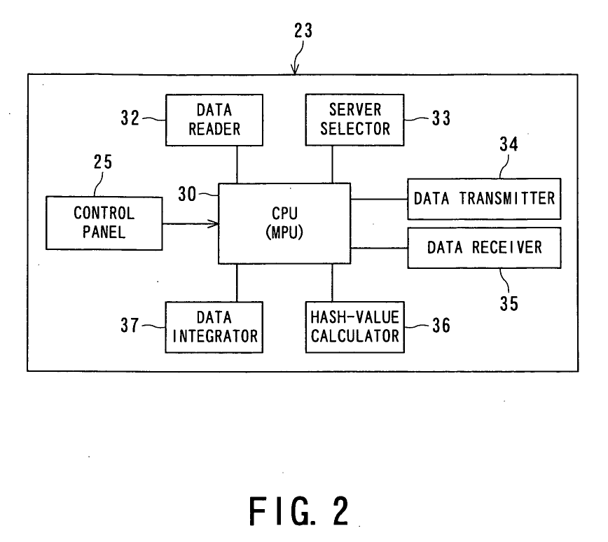

In view of such differences in server fee, the scanning device 23 of each of the MFPs 11 and 12 is provided with a server selector 33 (see FIG. 2) for selecting one of the primary time-stamping servers 15 and 20 according to the degree of importance of the scanned document data 26 on the basis of the job type and the degree of importance of the job. In response to the manual operation of the control panel 25, the server selector 33 selects one of the primary time-stamping servers 15 and 20 from which a time stamp is to be added to the scanned document data 26, on the basis of the job type and the degree of importance of the job, and according to the degree of importance of the scanned document data 26.

The scanning device 23 in each of the MFPs 11 and 12 uses the primary time-stamping server 15 or 20 to add a time stamp to the scanned document data 26.

As shown in FIG. 2, the scanning device 23 includes a central control unit 30, such as a CPU; the control panel 25 for controlling the central control unit 30; a data reader 32 for reading documents, such as contract and approval documents required to be maintained, under the control of the central control unit 30, and converting the read documents into electronic form, thereby generating the scanned document data 26; the server selector 33 for selecting one of the plurality of primary time-stamping servers 15 and 20 according to the degree of importance of the scanned document data 26; a data transmitter 34 for transmitting the generated scanned document data 26 to one of the primary time-stamping servers 15 and 20; a data receiver 35 for receiving the scanned document data 26 with a time stamp added by one of the primary time-stamping servers 15 and 20; a hash-value calculator 36 for calculating, on the basis of the scanned document data 26, a hash value for the purpose of data transmission; and a data integrator 37 for integrating the scanned document data 26 with the hash value calculated, transmitted to one of the primary time-stamping servers 15 and 20, and given a time stamp therefrom.

The server selector 33 is configured such that one of the plurality of the primary time-stamping servers 15 and 20 and its corresponding backup time-stamping server 16 or 21 can be selected together.

The central control unit 30 of the scanning device 23 causes the hash-value calculator 36 to calculate a hash value, on the basis of the scanned document data 26, for the purpose of data transmission, and causes the data transmitter 34 to send the calculated hash value of the scanned document data 26 to one of the primary time-stamping servers 15 and 20, where the hash value is given a time stamp. The data receiver 35 receives the time-stamped hash value of the scanned document data 26. The data integrator 37 integrates the received time-stamped hash value with the scanned document data 26, thereby forming time-stamped scanned document data 27 with an anti-tampering function.

The server selector 33 selects one of the primary time-stamping servers 15 and 20. The scanned document data 26 read by the scanning device 23 of each of the MFPs 11 and 12 is ranked according to the degree of importance of the scanned document data 26 on the basis of the job type and the degree of importance of the job. According to the degree of importance of the ranked scanned document data 26, the server selector 33 selects one of the primary time-stamping servers 15 and 20.

For example, if the scanned document data 26 is based on an important approval document or a contract document that involves the payment of high contract fees, the public primary time-stamping server 20 that issues time stamps with higher reliability is selected and accessed. Then, the scanned document data 26 is given a time stamp by the public primary time-stamping server 20. On the other hand, if the scanned document data 26 is data of a receipt or minutes that is based on a less important job while a time stamp is still required, the private primary time-stamping server 15 is selected and accessed. Then, the scanned document data 26 is given a time stamp by the private primary time-stamping server 15.

As described above, the degree of importance of the scanned document data 26 generated by the scanning device 23 of each of the MFPs 11 and 12 is determined according to the client's job type or the degree of importance of the job. Then, the primary time-stamping server 15 or 20 from which receives a time stamp is selected. The job types and the degrees of importance of the jobs are listed, in a systematic manner, in a manual table created in advance. The manual operation of the control panel 25 on the MFP 11 or 12, by referring to the manual table, causes the server selector 33 to select an automatically accessible server from the primary time-stamping servers 15 and 20.

The server selector 33 (see FIG. 2) for selecting a time-stamping server may be configured as template (job) buttons on the control panel 25. With the template buttons, every parameter for the scanning process in which the scanning device 23 reads a document can be selected. The template buttons are used to pre-select the primary time-stamping server 15 (20) and backup time-stamping server 16 (21) as one of the scanning parameters. If, when the template buttons are used, the primary time-stamping server 15 (20) is connected to another scanning device or is down and thus unavailable, access to the primary time-stamping server 15 (20) is automatically switched to the backup time-stamping server 16 (21), from which a time stamp is given to the scanned document data 26.

The time-stamped scanned document data 27 is returned to the scanning device 23 of the MFP 11 or 12. After the time authentication given to the corresponding document is confirmed on a display panel 39, the time-stamped scanned document data 27 is sent to and stored on the hard disk of the document management server 14. The time-stamped scanned document data 27 may be sent to the client PC 13, stored, and managed on the hard disk of the client PC 13.

The operation of the document management system 10 will now be described.

In the document management system 10, the scanning device 23 starts up when the MFP 11 or 12 is turned on.

In step ST1, the operation of the control panel 25 of the MFP 11 or 12 causes the server selector 33 to select the primary time-stamping server 15 (20) and the backup time-stamping server 16 (21). The degree of importance of a document to be read by the scanning device 23 is determined in advance on the basis of a manual table or the like, and thus is known at the time of reading.

Then, a set of primary and backup time-stamping servers is selected according to the degree of importance of the document. For example, if the degree of importance of the document is high, the public primary and backup time-stamping servers 20 and 21 are selected. If the degree of importance of the document is relatively low, the private primary and backup time-stamping servers 15 and 16 are selected. Documents may be ranked into several importance levels, and a set of primary and backup time-stamping servers may be selected from a plurality of sets of primary and backup time-stamping servers according to the level.

Next, the scanning device 23 starts up. With the operation of the control panel 25, the scanning device 23 scans, for example, a contract document, an approval document, or minutes to generate the scanned document data 26 including image data. The scanned document data 26 may be generated, by the scanning device 23, in advance and stored in the MFP 11 (12).

With the operation of the template buttons of the control panel 25 on the MFP 11 (12), the private time-stamping servers 15 and 16 or the public time-stamping servers 20 and 21 are selected.

After the server selection, the scanning device 23 scans a document to generate the scanned document data 26 in step ST □.

A large amount of scanned document data 26, such as 200 kilobytes of data, is generated. To reduce the amount of data, a hash value for data transmission is calculated in step ST3. A hash value is a mathematical algorithm incorporated in the scanning device 23 for easy and fast data transmission. For example, MD-5 with a 128-bit hash value, SHA-1, and SHA-160 are used as de facto standards.

After the hash value is calculated for the transmission of the scanned document data 26, the primary time-stamping server 15 or 20 is accessed. In step ST4, it is determined whether or not the primary time-stamping server 15 or 20 is available.

If the primary time-stamping server 15 or 20 is available, the hash value of the scanned document data 26 is sent to the primary time-stamping server 15 or 20 in step ST5. An ID number and an access permission number of each scanned document data 26 is attached to the hash value of the scanned document data 26.

Upon receipt of the hash value of the scanned document data 26, the primary time-stamping server 15 or 20 adds a time stamp to the hash value. The time-stamped hash value is returned to and received by the MFP 11 (12) in step ST6.

In the MFP 11 (12), the time-stamped hash value and the scanned document data 26 are automatically integrated into the time-stamped scanned document data 27. The scanned document data 26 can thus be prevented from being tampered. Thus, the scanning device 23 can add a time stamp to the scanned document data 26 using the primary time-stamping server 15 or 20 assigned to the scanned document data 26. The received time-stamped scanned document data 27 is sent from the MFP 11 (12) via the LAN to the document management server 14. Upon receipt, the document management server 14 stores the time-stamped scanned document data 27 on its hard disk in step ST7, thereby completing a series of document management operations. The time-stamped scanned document data 27 may be sent to, stored, and managed on the client PC 13, instead of the document management server 14.

On the other hand, if the primary time-stamping server 15 or 20 is not available, the primary time-stamping server 15 or 20 is automatically switched to the backup time-stamping server 16 or 21. Then, in step ST8, the hash value of the scanned document data 26 is sent to the backup time-stamping server 16 or 21.

The backup time-stamping server 16 or 21 receives the hash value of the scanned document data 26 and adds a time stamp to the hash value. The time-stamped hash value is returned to the MFP 11 (12), and integrated with the scanned document data 26 in the scanning device 23. The time-stamped scanned document data 27 is thus generated.

Then, the time-stamped scanned document data 27 is sent to the document management server 14 or to the client PC 13. The document management server 14 or the client PC 13 receives and stores the time-stamped scanned document data 27 on its hard disk, thereby completing a series of document management operations.

The document management system 10 causes the scanning device 23 of the MFP 11 or 12 to generate the scanned document data 26. The generated scanned document data 26 is ranked on the basis of the manual table according to the degree of importance of the document. The server selector 33 selects one of the primary time-stamping servers 15 and 20 according to the degree of importance of the scanned document data 26. The server fees of the primary time-stamping servers 15 and 20 are different because of the difference in reliability of the time stamps. The server fees of primary time-stamping servers that issue time stamps with higher reliability are more expensive than those of other servers.

Therefore, since a server can be selected, according to the degree of importance of the scanned document data 26, from the primary time-stamping servers 15 and 20 issuing time stamps with different degrees of reliability, server costs can be managed according to the degree of importance of the scanned document data 26. Thus, document management operations can be performed in a more efficient and economical manner than those in conventional cases where server fees are uniform.

In the document management system 10, if the primary time-stamping server 15 or 20 is down and unavailable, the primary time-stamping server 15 or 20 is automatically switched to the backup time-stamping server 16 or 21 under the conditions automatically specified in a flowchart in the central control unit 30, such as a CPU, connected to the control panel 25 on the MFP 11 or 12.

The risks of tampering with the scanned document data 26 vary depending on the reliability of the time stamp. Since time stamps for public authentication are highly reliable, the scanned document data 26 based on a document that the client (company) considers particularly important to maintain is given a time stamp by the public primary time-stamping server 20.

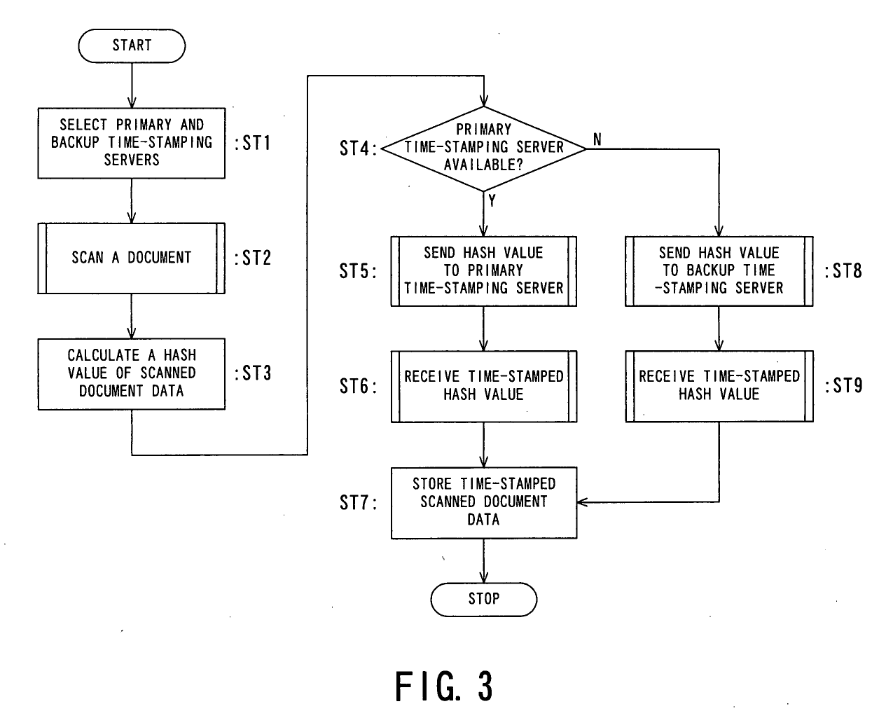

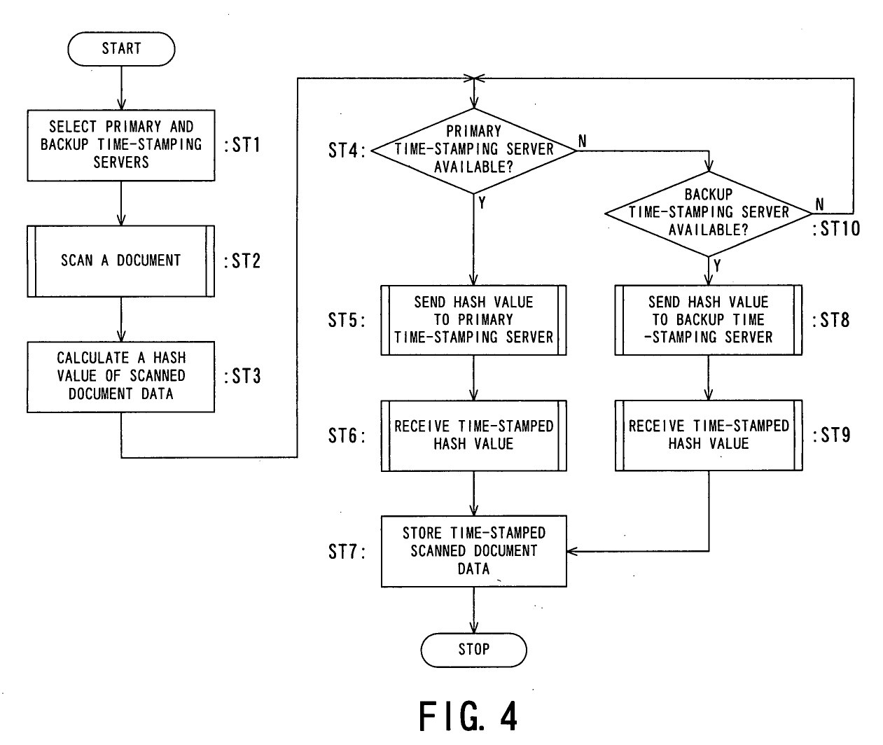

In the embodiment described above, the primary time-stamping server 15 or 20 and its corresponding backup time-stamping server 16 or 21 are selected before the transmission of the scanned document data 26. However, the central control unit 30 may be programmed such that only the primary time-stamping server 15 or 20 is initially selected, and the backup time-stamping server 16 or 21 is automatically selected if the primary time-stamping server 15 or 20 is busy or down and is unavailable. In this case, it is preferable, as shown in FIG. 4, that step ST10 for determining whether or not a backup time-stamping server is available be added between steps ST4 and ST8 in FIG. 3.

A series of document management operations in this case is as illustrated in the flowchart in FIG. 4. If the backup time-stamping server 16 or 21 is available, the process proceeds to step ST9 and if not available, the process returns to step ST4.

What is claimed is:

1. A document management system comprising:
a scanning device for reading necessary documents, such as contract documents and approval documents, that are required to be maintained, and generating scanned document data;
a plurality of primary time-stamping servers for issuing time stamps with varying degrees of reliability, each server adding a time stamp to the scanned document data generated;
a server selector for selecting a specific primary time-stamping server from the plurality of primary time-stamping servers according to the degree of importance of the scanned document data; and
a document management server for receiving and storing the scanned document data with a time stamp given by the selected primary time-stamping server,
wherein the scanning device is configured to use one of the plurality of primary time-stamping servers to add a time stamp to scanned document data.

2. The document management system according to claim 1, wherein the plurality of primary time-stamping servers are ranked according to the reliability of the time stamps.

3. The document management system according to claim 1, wherein the plurality of primary time-stamping servers include one or a plurality of public primary time-stamping servers that issue time stamps with higher reliability, and one or a plurality of private primary time-stamping servers that issue time stamps with lower reliability.

4. The document management system according to claim 1, wherein each of the plurality of primary time-stamping servers is provided with its corresponding backup time-stamping server and configured such that, if a primary time-stamping server is not available, its corresponding backup time-stamping server can be used instead.

5. The document management system according to claim 4, wherein the backup time-stamping server issues time stamps with reliability equal to or higher than that of time stamps issued by its corresponding primary time-stamping server.

6. The document management system according to claim 1, wherein the document management server for storing scanned document data with time stamps is a client's PC.

7. A scanning device for adding a time stamp to scanned document data by using one of a plurality of primary time-stamping servers, the scanning device comprising:
a central control unit such as a CPU;
a control panel for controlling the central control unit;
a data reader for reading necessary documents, such as contract documents and approval documents, that are required to be maintained, and generating scanned document data under the control of the central control unit;
a server selector for selecting a specific primary time-stamping server from the plurality of primary time-stamping servers according to the degree of importance of the scanned document data;
a data transmitter for sending generated scanned document data to a specific primary time-stamping server; and
a data receiver for receiving scanned document data with a time stamp given by a specific primary time-stamping server,
wherein the data transmitter is configured such that scanned document data with a time stamp is sent to and stored on a document management server.

8. The scanning device according to claim 7, wherein the server selector is configured such that each of the plurality of primary time-stamping servers can be selected together with its corresponding backup time-stamping server.

9. The scanning device according to claim 7, wherein the central control unit is provided with a hash-value calculator for calculating a hash value for data transmission on the basis of scanned document data; causes the data transmitter to send the hash value of the scanned document data to a primary time-stamping server where a time stamp is added to the hash value of the scanned document data; causes the data receiver to receive the time-stamped hash value; is further provided with a data integrator for integrating scanned document data with a received time-stamped hash value; causes the data integrator to integrate the scanned document data with the time-stamped hash value and to generate time-stamped scanned document data; and thus provides an anti-tampering function.

10. The scanning device according to claim 8, wherein the scanning device is included in at least one of a multi-function printer, a digital copier, and an image scanner.
